(19) United States
(12) Patent Application Publication
(10) Pub. No.: US 2017/0308773 A1
(43) Pub. Date: Oct. 26, 2017

(54) LEARNING DEVICE, LEARNING METHOD, AND NON-TRANSITORY COMPUTER READABLE STORAGE MEDIUM

(71) Applicant: YAHOO JAPAN CORPORATION, Tokyo (JP)

(72) Inventors: Takashi MIYAZAKI, Tokyo (JP); Nobuyuki SHIMIZU, Tokyo (JP)

(73) Assignee: YAHOO JAPAN CORPORATION, Tokyo (JP)

(21) Appl. No.: 15/426,564

(22) Filed: Feb. 7, 2017

(30) Foreign Application Priority Data
Apr. 26, 2016 (JP) 2016-088493

(51) Int. Cl. G06K 9/62; G06N 3/08; G06N 3/04

(52) U.S. Cl. CPC G06K 9/6256; G06N 3/04; G06N 3/08

(57) ABSTRACT

According to one aspect of an embodiment a learning device includes a generating unit that generates a new second learner by using a part of a first learner in which deep learning has been performed on the relationship held by a combination of first content and second content that has a type different from that of the first content. The learning device includes a learning unit that allows the second learner generated by the generating unit to perform deep learning on the relationship held by a combination of the first content and third content that has a type different from that of the second content.

### CROSS-REFERENCE TO RELATED APPLICATIONS

The present application claims priority to and incorporates by reference the entire contents of Japanese Patent Application No. 2016-088493 filed in Japan on Apr. 26, 2016.

### BACKGROUND OF THE INVENTION

### 1. Field of the Invention

The present invention relates to a learning device, a learning method, and a non-transitory computer readable storage medium.

### 2. Description of the Related Art

Conventionally, there is a known learning technology that learns a learner that previously learns the relationship, such as co-occurrence, included in a plurality of pieces of data and that outputs, if some data is input, another piece of data that has the relationship with the input data. As an example of such a learning technology, there is a known learning technology that uses a combination of a language and a non-verbal language as learning data and that learns the relationship included in the learning data.

Patent Document 1: Japanese Laid-open Patent Publication No. 2011-227825

However, with the learning technology described above, if the number of pieces of the learning data is small, the accuracy of learning may possibly be degraded.

### SUMMARY OF THE INVENTION

It is an object of the present invention to at least partially solve the problems in the conventional technology.

According to one aspect of an embodiment a learning device includes a generating unit that generates a new second learner by using a part of a first learner in which deep learning has been performed on the relationship held by a combination of first content and second content that has a type different from that of the first content. The learning device includes a learning unit that allows the second learner generated by the generating unit to perform deep learning on the relationship held by a combination of the first content and third content that has a type different from that of the second content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an example of a learning process performed by an information providing device according to an embodiment;

FIG. 2 is a block diagram illustrating the configuration example of the information providing device according to the embodiment;

FIG. 3 is a schematic diagram illustrating an example of information registered in a first learning database according to the embodiment;

FIG. 4 is a schematic diagram illustrating an example of information registered in a second learning database according to the embodiment;

FIG. 5 is a schematic diagram illustrating an example of a process in which the information providing device according to the embodiment performs deep learning on a first model;

FIG. 6 is a schematic diagram illustrating an example of a process in which the information providing device according to the embodiment performs deep learning on a second model;

FIG. 7 is a schematic diagram illustrating an example of the result of the learning process performed by the information providing device according to the embodiment;

FIG. 8 is a schematic diagram illustrating the variation of the learning process performed by the information providing device according to the embodiment;

FIG. 9 is a flowchart illustrating the flow of the learning process performed by the information providing device according to the embodiment; and

FIG. 10 is a block diagram illustrating an example of the hardware configuration.

### DETAILED DESCRIPTION OF THE PREFERRED EMBODIMENTS

Hereinafter, a mode (hereinafter, referred to as an “embodiment”) for carrying out a learning device, a learning method, and a non-transitory computer readable storage medium according to the present invention will be explained in detail below with reference to the accompanying drawings. The learning device, the learning method, and the non-transitory computer readable storage medium according to the present invention are not limited by the embodiment. Furthermore, in the embodiment below, the same components are denoted by the same reference numerals and the same explanation will be omitted.

### 1-1. Example of an Information Providing Device

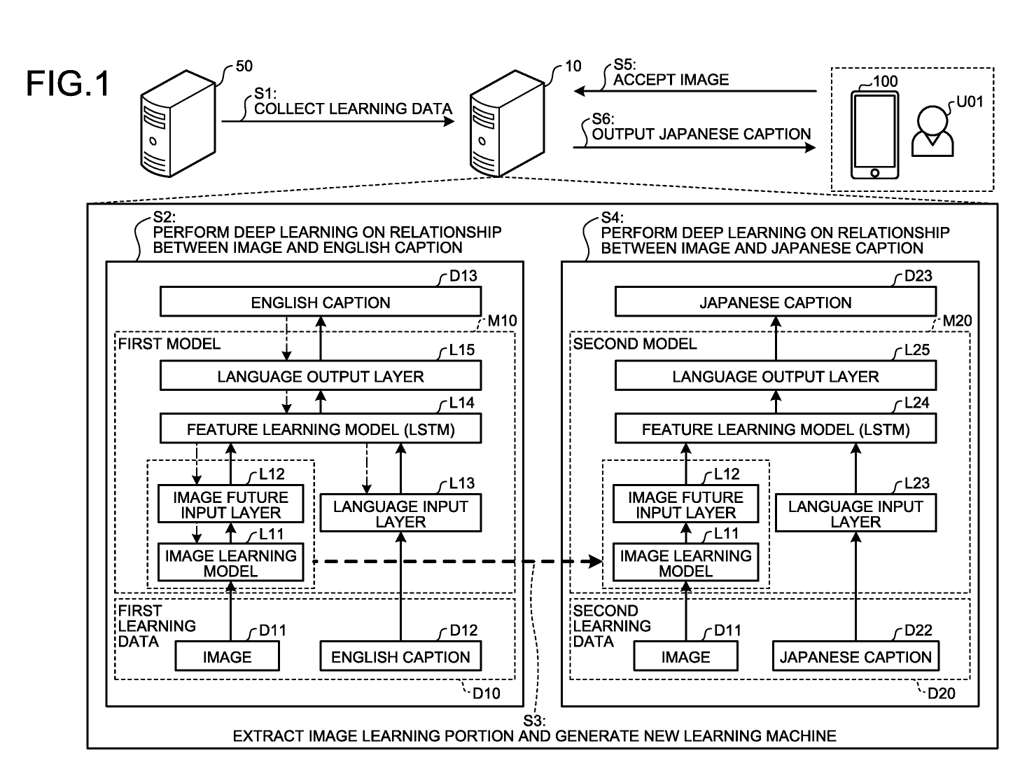

First, a description of an example of a learning process performed by an information providing device that is an example of the learning process will be described with reference to FIG. 1. FIG. 1 is a schematic diagram illustrating an example of a learning process performed by an information providing device according to an embodiment. In FIG. 1, an information providing device 10 can communicate with a data server 50 and a terminal device 100 that are used by a predetermined client via a predetermined network N, such as the Internet, or the like.

The information providing device 10 is an information processing apparatus that performs the learning process, which will be described later, and is implemented by, for example, a server device, a cloud system, or the like. Furthermore, the data server 50 is an information processing apparatus that manages learning data that is used when the information providing device 10 performs the learning process, which will be described later, and is implemented by, for example, the server device, the cloud system, or the like.

The terminal device 100 is a smart device, such as a smart phone, a tablet, or the like and is a mobile terminal device that can communicate with an arbitrary server device via a wireless communication network, such as the 3^{rd} generation (3G), long term evolution (LTE), or the like. Furthermore, the terminal device 100 may also be, in addition to the smart device, an information processing apparatus, such as a desktop personal computer (PC), a notebook PC, or the like.

### 1-2. About the Learning Data

In the following, the learning data managed by the data server 50 will be described. The learning data managed by the data server 50 is a combination of a plurality of pieces of data with different types, such as a combination of, for example, first content that includes therein an image, a moving image, or the like and second content that includes therein a sentence described in an arbitrary language, such as the English language, the Japanese language, or the like. More specifically, the learning data is data obtained by associating an image in which an arbitrary capturing target is captured with a sentence, i.e., the caption of the image, that explains the substance of the image, such as the image is what kind of image, what kind of capturing target is captured in the image, what kind of state is captured in the image, or the like.

The learning data in which the image is and the caption are associated with each other in this way is generated and registered by an arbitrary user, such as a volunteer, or the like, in order to use for arbitrary machine learning. Furthermore, in the learning data generated in this way, there may sometimes be a case in which a plurality of captions generated from various viewpoints is associated with a certain image and there may also be a case in which captions described in various languages, such as the Japanese language, the English language, the Chinese language, or the like, are associated with the certain image.

In a description below, an example of using both the images and the captions that are described in various languages are used as learning data will be described; however, the embodiment is not limited to this. For example, the learning data may also be data in which the content, such as music, a movie, or the like, is associated with a review of a user with respect to the associated content or may also be data in which the content, such as an image, a moving image, or the like, is associated with music that is fit with the associated content. Namely, regarding the learning process, which will be described later, any learning data that includes arbitrary content can be used as long as the learning data in which the first content is associated with second content that has a type different from that of the first content is used.

### 1-3. Example of the Learning Process

Here, the information providing device 10 performs, by using the learning data managed by the data server 50, the learning process of generating a model in which deep learning has been performed on the relationship between the image and the caption that are included in the learning data. Namely, the information providing device 10 previously generates a model in which a plurality of layers including a plurality of nodes, such as a neural network or the like, is layered and allows the generated model to learn the relationship (for example, co-occurrence, or the like) between each of the pieces of the content included in the learning model. The model in which such deep learning has been performed can output, when, for example, an image is input, the caption that explains the input image or can search for or generate, when the caption is input, an image similar to the image indicated by the caption and can output the image.

Here, in deep learning, the accuracy of the learning result obtained from the model is increased as the number of pieces of learning data is greater. However, depending on the type of content included in the learning data, there may sometimes be a case in which the learning data is not able to sufficiently be secured. For example, regarding the learning data in which an image is associated with the caption in the English language (hereinafter, referred to as the “English caption”), there is the number of pieces of the learning data by which the accuracy of the learning result obtained from the model is sufficiently secured. However, the number of pieces of learning data in each of which an image is associated with the caption in the Japanese language (hereinafter, referred to as the “Japanese caption”) is less than the number of pieces of the learning data in each of which the image is associated with the English caption. Consequently, there may sometimes be a case in which the information providing device 10 is not able to accurately learn the relationship between the image and the Japanese caption.

Thus, the information providing device 10 performs the learning process described below. First, the information providing device 10 generates a new second model by using a combination of the first content and the second content that has a type different from that of the first content, i.e., by using a part of the first model in which deep learning has been performed on the relationship held by the learning data. Then, the information providing device 10 allows the generated second model to perform deep learning on the relationship held by a combination between the first content and third content that has a type different from that of the second content.

### 1-4. Specific Example of the Learning Process

In the following, an example of the learning process performed by the information providing device 10 will be described with reference to FIG. 1. First, the information providing device 10 collects learning data from the data server 50 (Step S1). More specifically, the information providing device 10 acquires both the learning data in which an image is associated with the English caption (hereinafter, referred to as “first learning data”) and the learning data in which an image is associated with the Japanese caption (hereinafter, referred to as “second learning data”). Then, by using the first learning data, the information providing device 10 allows the first model to perform deep learning on the relationship between the image and the English caption (Step S2). In the following, an example of a process of performing, by the information providing device 10, deep learning on the first model will be described.

### 1-4-1. Example of a Learning Model

First, the configuration of a first model M10 and a second model M20 generated by the information providing device 10 will be described. For example, the information providing device 10 generates the first model M10 having the configuration such as that illustrated in FIG. 1. Specifically, the information providing device 10 generates the first model M10 that includes therein an image learning model L11, an image feature input layer L12, a language input layer L13, a feature learning model L14, and a language output layer L15 (hereinafter, sometimes referred to as “each of the layers L11 to L15”).

The image learning model L11 is a model that extracts, if an image D11 is input, the feature of the image D11, such as what is the object captured in the image D11, the number of captured objects, the color or the atmosphere of the image D11, or the like, and is implemented by, for example, a deep neural network (DNN). More specifically, the image learning model L11 uses a convolutional network for image classification called the Visual Geometry Group Network (VGGNet). If an image is input, the image learning model L11 inputs the input image to the VGGNet and then outputs, to the image feature input layer L12 instead of the output layer included in the VGGNet, an output of a predetermined intermediate layer. Namely, the image learning model L11 outputs, to the image feature input layer L12, the output that indicates the feature of the image D11, instead of the recognition result of the capturing target that is included in the image D11.

The image feature input layer L12 performs conversion in order to input the output of the image learning model L11 to the feature learning model L14. For example, the image feature input layer L12 outputs, to the feature learning model L14, the signal that indicates what kind of feature has been extracted by the image learning model L11 from the output of the image learning model L11. Furthermore, the image feature input layer L12 may also be a single layer that connects, for example, the image learning model L11 to the feature learning model L14 or may also be a plurality of layers.

The language input layer L13 performs conversion in order to input the language included in the English caption D12 to the feature learning model L14. For example, when the language input layer L13 accepts an input of the English caption D12, the language input layer L13 converts the input data to the signal that indicates what kind of words are included in the input English caption D12 in what kind of order and then outputs the converted signal to the feature learning model L14. For example, the language input layer L13 outputs the signal that indicates the word included in the English caption D12 to the feature learning model L14 in the order in which each of the words is included in the English caption D12. Namely, when the language input layer L13 accepts an input of the English caption D12, the language input layer L13 outputs the substance of the received English caption D12 to the feature learning model L14.

The feature learning model L14 is a model that learns the relationship between the image D11 and the English caption D12, i.e., the relationship of a combination of the content included in the first learning data D10 and is implemented by, for example, a recurrent neural network, such as the long short-term memory (LSTM) network, or the like. For example, the feature learning model L14 accepts an input of the signal that is output from the image feature input layer L12, i.e., the signal indicating the feature of the image D11. Then, the feature learning model L14 sequentially accepts an input of the signals that are output from the language input layer L13. Namely, the feature learning model L14 accepts an input of the signals indicating the corresponding words included in the English caption D12 in the order of the words that appear in the English caption D12. Then, the feature learning model L14 sequentially outputs, to the language output layer L15, the signal that is in accordance with the substance of the input image D11 and the English caption D12. More specifically, the feature learning model L14 sequentially outputs the signals indicating the words included in the output sentence in the order of the words that are included in the output sentence.

The language output layer L15 is a model that outputs a predetermined sentence on the basis of the signal output from the feature learning model L14 and is implemented by, for example, a DNN. For example, the language output layer L15 generates, from the signals that are sequentially output from the feature learning model L14, a sentence that is to be output and then outputs the generated signals.

### 1-4-2. Example of Learning of the First Model

Here, when the first model M10 having this configuration accepts an input of, for example, the image D11 and the English caption D12, the first model M10 outputs the English caption D13, as output sentence, on the basis of both the feature that is extracted from the image D11, which is the first content, and the substance of the English caption D12, which is the second content. Thus, the information providing device 10 performs the learning process that optimizes the entirety of the first model M10 such that the substance of the English caption D13 approaches the substance of the English caption D12. Consequently, the information providing device 10 can allow the first model M10 to perform deep learning on the relationship held by the first learning data D10.

For example, by using the technology of optimization, such as back propagation, or the like, that is used for deep learning, the information providing device 10 optimizes the entirety of the first model M10 by sequentially modifying the coefficient of connection between the nodes from the nodes on the output side to the nodes on the input side included in the first model M10. Furthermore, the optimization of the first model M10 is not limited to back propagation. For example, if the feature learning model L14 is implemented by a support vector machine (SVM), the information providing device 10 may also optimize the entirety of the first model M10 by using a different method of optimization.

### 1-4-3. Example of Generating the Second Model

Here, if the entirety of the first model M10 has been optimized so as to learn the relationship held by the first learning data D10, it is conceivable that the image learning model L11 and the image feature input layer L12 attempt to extract the feature from the image D11 such that the first model M10 can accurately learn the relationship between the image D11 and the English caption D12. For example, it is conceivable to form, in the image learning model L11 and the image feature input layer L12, a bias that can be used by the feature learning model L14 to accurately learn the feature of the association relationship between the capturing target that is included in the image D11 and the words that are included in the English caption D12.

More specifically, in the first model M10 having the structure illustrated in FIG. 1, the image learning model L11 is connected to the image feature input layer L12 and the image feature input layer L12 is connected to the feature learning model L14. If the entirety of the first model M10 having this configuration is optimized, it is conceivable that, in the image feature input layer L12 and the image learning model L11, the substance obtained by performing deep learning by the feature learning model L14, i.e., the relationship between the subject of the image D11 and the meaning of the words that are included in the English caption D12, is reflected to some extent.

In contrast, regarding the English language and the Japanese language, the meanings of the both sentences are the same but the grammar of the both languages differs (i.e., the appearance order of words). Consequently, even if the information providing device 10 uses the language input layer L13, the feature learning model L14, and the language output layer L15 without modification, the information providing device 10 does not always skillfully extract the relationship between the image and the Japanese caption.

Thus, the information providing device 10 generates the second model M20 by using a part of the first model M10 and allows the second model M20 to perform deep learning on the relationship between the image D11 and the Japanese caption D22 that are included in the second learning data D20. More specifically, the information providing device 10 extracts an image learning portion that includes therein the image learning model L11 and the image feature input layer L12 that are included in the first model M10 and then generates the new second model M20 that includes therein the extracted image learning portion (Step S3).

Namely, the first model M10 includes the image learning portion that extracts the feature of the image D11 that is the first content; the language input layer L13 that accepts an input of the English caption D12 that is the second content; and the feature learning model L14 and the language output layer L15 that output, on the basis of the output from the image learning portion and the output from the language input layer L13, the English caption D13 that has the same substance as that of the English caption D12. Then, the information providing device 10 generates the new second model M20 by using at least the image learning portion included in the first model M10.

More specifically, the information providing device 10 generates the second model M20 having the same configuration as that of the first model M10 by adding, to the image learning portion in the first model M10, a new language input layer L23, a new feature learning model L24, and a new language output layer L25. Namely, the information providing device 10 generates the second model M20 in which an addition of a new portion or a deletion is performed on a part of the first model M10.

Then, the information providing device 10 allows the second model M20 to perform deep learning on the relationship between the image and the Japanese caption (Step S4). For example, the information providing device 10 inputs both the image D11 and the Japanese caption D22 that are included in the second learning data D20 to the second model M20 and then optimizes the entirety of the second model M20 such that the Japanese caption D23, as output sentence, that is output by the second model M20 becomes the same as the Japanese caption D22.

Here, regarding the image learning portion that is included in the first model M10 and that was used to generate the second model M20, the substance of the learning the feature learning model L14, i.e., the relationship between the subject of the image D11 and the meaning of the words that are included in the English caption D12, is reflected to some extent. Thus, by using the second model M20 that includes such an image learning portion, if the relationship between the image D11 and the Japanese caption D22 that are included in the second learning data D20 is learned, it is conceivable that the second model M20 more promptly (accurately) learn the association between the subject that is included in the image D11 and the meaning of the words that are included in the Japanese caption D22. Consequently, even if the information providing device 10 is not able to sufficiently secure the number of pieces of the second learning data D20, the information providing device 10 can allow the second model M20 to accurately learn the relationship between the image D11 and the Japanese caption D22.

### 1-5. Example of a Providing Process

Here, because the second model M20 learned by the information providing device 10 has learned the co-occurrence of the image D11 and the Japanese caption D22, when, for example, only another image is input, the second model M20 can automatically generates the Japanese caption that co-occurs with the input image, i.e., the Japanese caption that indicates the input image. Thus, the information providing device 10 may also implement, by using the second model M20, the service that automatically generates a Japanese caption and that provides the generated Japanese caption.

For example, the information providing device 10 accepts an image that is targeted for a process from the terminal device 100 that is used by a user U01 (Step S5). In such a case, the information providing device 10 inputs, to the second model M20, the image that has been accepted from the terminal device 100 and then outputs, to the terminal device 100, the Japanese caption that has been output by the second model, i.e., the Japanese caption D23 that indicates the image accepted from the terminal device 100 (Step S6). Consequently, the information providing device 10 can provide the service that automatically generates the Japanese caption D23 with respect to the image received from the user U01 and that outputs the generated caption.

### 1-6. About Generation of the First Model

In the example described above, the information providing device 10 generates the second model M20 by using a part of the first learning data D10 collected from the data server 50. However, the embodiment is not limited to this. For example, the information providing device 10 may also acquire, from an arbitrary server, the first model M10 that has already learned the relationship between the image D11 and the English caption D12 that are included in the first learning data D10 and may also generate the second model M20 by using a part of the acquired first model M10.

Furthermore, the information providing device 10 may also generate the second model M20 by using only the image learning model L11 included in the first model M10. Furthermore, if the image feature input layer L12 includes a plurality of layers, the information providing device 10 may also generate the second model M20 by using all of the layers or may also generate the second model M20 by using, for example, a predetermined number of layers from among the input layers each of which accepts an output from the image learning model L11 or a predetermined number of layers from among the output layers each of which outputs a signal to the feature learning model L24.

Furthermore, the structure held by the first model M10 and the second model M20 (hereinafter, sometimes referred to as “each model”) is not limited to the structure illustrated in FIG. 1. Namely, the information providing device 10 may also generate a model having an arbitrary structure as long as deep learning can be performed on the relationship of the first learning data D10 or the relationship of the second learning data D20. For example, the information providing device 10 generates a single DNN, in total, as the first model M10 and learns the relationship of the first learning data D10. Then, the information providing device 10 may also extract, as an image learning portion, the nodes that are included in a predetermined range, in the first model M10, from among the nodes each of which accepts an input of the image D11 and may also newly generate the second model M20 that includes the extracted image learning portion.

### 1-7. About the Learning Data

Here, the explanation described above, the information providing device 10 allows each of the models to perform deep learning on the relationship between the image and the English or the Japanese caption (sentence). However, the embodiment is not limited to this. Namely, the information providing device 10 may also perform the learning process described above about the learning data that includes therein the content having an arbitrary type. More specifically, the information providing device 10 can use the content that has an arbitrary type as long as the information providing device 10 allows the first model M10 to perform deep learning on the relationship of the first learning data D10 that is a combination between the first content that has an arbitrary type and the second content that is different from the first content; generates the second model M20 from a part of the first model M10; and allows the second model M20 to perform deep learning on the relationship of the second learning data D20 that is a combination of the first content and the third content that as a type (for example, a language is different) different from that of the second content.

For example, the information providing device 10 may also allow the first model M10 to perform deep learning on the relationship held by a combination of the first content related to a non-verbal language and the second content related to a language; may also generate the new second model M20 by using a part of the first model M10; and may also allow the second model M20 to perform deep learning on the relationship held by a combination of the first content and the third content that is related to a language different from that of the second content. Furthermore, if the first content is an image or a moving image, the second content or the third content may also be a sentence, i.e., a caption, that includes therein the explanation of the first content.

### 2. Configuration of the Information Providing Device

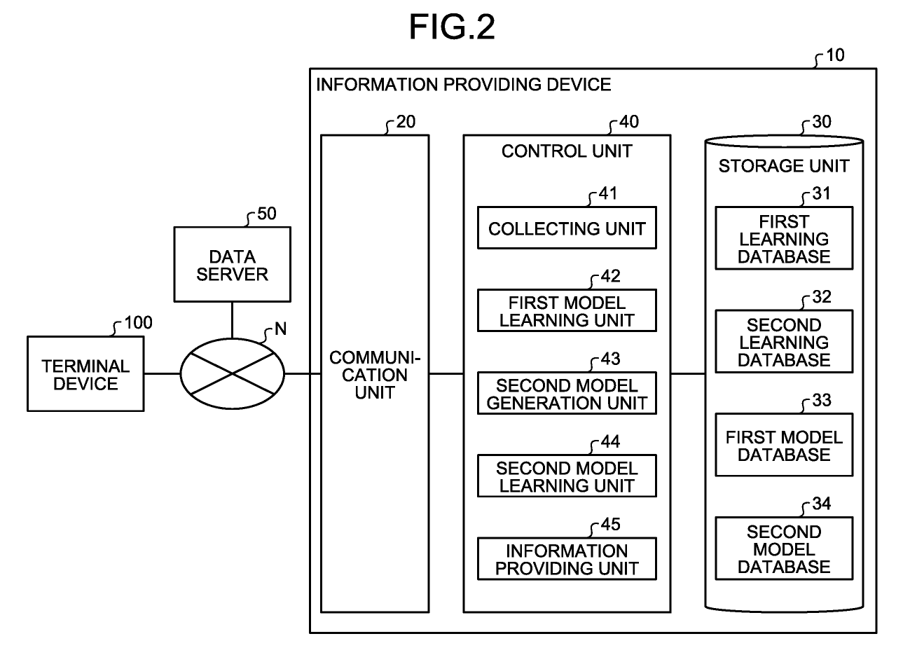

In the following, a description will be given of an example of the functional configuration included by the information providing device 10 that implements the learning process described above. FIG. 2 is a block diagram illustrating the configuration example of the information providing device according to the embodiment. As illustrated in FIG. 2, the information providing device 10 includes a communication unit 20, a storage unit 30, and a control unit 40.

The communication unit 20 is implemented by, for example, a network interface card (NIC), or the like. Then, the communication unit 20 is connected to a network N in a wired or a wireless manner and sends and receives information to or from the terminal device 100 or the data server 50.

The storage unit 30 is implemented by, for example, a semiconductor memory device, such as a random access memory (RAM), a flash memory, or the like, or a storage device, such as a hard disk, an optical disk, or the like. Furthermore, the storage unit 30 stores therein a first learning database 31, a second learning database 32, a first model database 33, and a second model database 34.

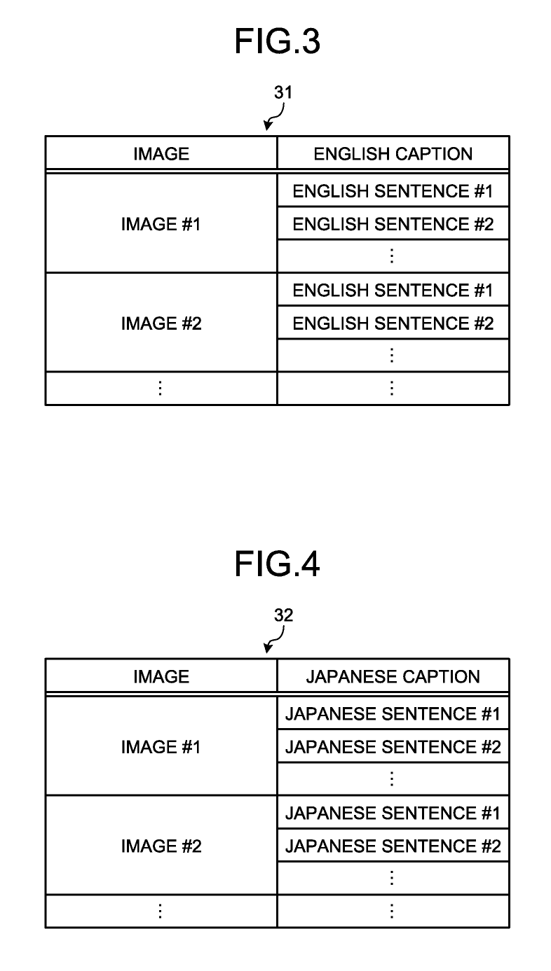

The first learning data D10 is registered in the first learning database 31. For example, FIG. 3 is a schematic diagram illustrating an example of information registered in a first learning database according to the embodiment. As illustrated in FIG. 3, in the first learning database 31, the information, i.e., the first learning data D10, that includes the items, such as an “image” and the “English caption”, are registered. Furthermore, the example illustrated in FIG. 3 illustrates, as the first learning data D10, a conceptual value, such as an “image #1” or an “English sentence #1”; however, in practice, various kinds of image data, a sentence described in the English language, or the like is registered.

For example, in the example illustrated in FIG. 3, the English caption of the “English sentence #1” and the English caption of an “English sentence #2” are associated with the image of the “image #1”. This type of information indicates that, in addition to data on the image of the “image #1”, the English caption of the “English sentence #1”, which is the caption of the image of the “image #1” described in the English language, and the English caption of the “English sentence #2” are associated with each other and registered.

The second learning data D20 is registered in the second learning database 32. For example, FIG. 4 is a schematic diagram illustrating an example of information registered in a second learning database according to the embodiment. As illustrated in FIG. 4, in the second learning database 32, the information, i.e., the second learning data D20, that includes the items, such as an “image” and a “Japanese caption”, are registered. Furthermore, the example illustrated in FIG. 4 illustrates, as the second learning data D20, a conceptual value, such as an “image #1” or a “Japanese sentence #1”; however, in practice, various kinds of image data, a sentence described in the Japanese language, or the like are registered.

For example, in the example illustrated in FIG. 4, Japanese caption of the “Japanese sentence #1” and the Japanese caption of the “Japanese sentence #2” are associated with the image of the “image #1”. This type of information indicates that, in addition to data on the image of the “image #1”, the Japanese caption of the “Japanese sentence #1”, which is the caption of the image of the “image #1” in the Japanese language, and the Japanese caption of the “Japanese sentence #2” are associated with each other and registered.

Referring back to FIG. 2 and the description will be continued. In the first model database 33, the data on the first model M10 in which deep learning has been performed on the relationship of the first learning data D10. For example, in the first model database 33, the information that indicates each of the nodes arranged in each of the layers L11 to L15 in the first model M10 and the information that indicates the coefficient of connection between the nodes are registered.

In the second model database 34, the data on the second model M20 in which deep learning has been performed on the relationship of the second learning data D20 is registered. For example, in the second model database 34, the information that indicates the nodes arranged in the image learning model L11, the image feature input layer L12, the language input layer L23, the feature learning model L24, and the language output layer L25 that are included in the second model M20 and the information that indicates the coefficient of connection between the nodes are registered.

The control unit 40 is a controller and is implemented by, for example, a processor, such as a central processing unit (CPU), a micro processing unit (MPU), or the like, executing various kinds of programs, which are stored in a storage device in the information providing device 10, by using a RAM or the like as a work area. Furthermore, the control unit 40 is a controller and may also be implemented by, for example, an integrated circuit, such as an application specific integrated circuit (ASIC), a field programmable gate array (FPGA), or the like.

As illustrated in FIG. 2, the control unit 40 includes a collecting unit 41, a first model learning unit 42, a second model generation unit 43, a second model learning unit 44, and an information providing unit 45. The collecting unit 41 collects the learning data D10 and D20. For example, the collecting unit 41 collects the first learning data D10 from the data server 50 and registers the collected first learning data D10 in the first learning database 31. Furthermore, the collecting unit 41 collects the second learning data D20 from the data server 50 and registers the collected second learning data D20 in the second learning database 32.

The first model learning unit 42 performs the deep learning on the first model M10 by using the first learning data D10 registered in the first learning database 31. More specifically, the first model learning unit 42 generates the first model M10 having the structure illustrated in FIG. 1 and inputs the first learning data D10 to the first model M10. Then, the first model learning unit 42 optimizes the entirety of the first model M10 such that the English caption D13 that is output by the first model M10 and the English caption D12 that is included in the input first learning data D10 have the same content. Furthermore, the first model learning unit 42 performs the optimization described above on the plurality of the pieces of the first learning data D10 included in the first learning database 31 and then registers the first model M10 in which optimization has been performed on the entirety thereof in the first model database 33. Furthermore, regarding the process that is used by the first model learning unit 42 to optimize the first model M10, it is assumed that an arbitrary method related to deep learning can be used.

The second model generation unit 43 generates the new second model M20 by using a part of the first model M10 in which deep learning has been performed on the relationship held by the combination of the first content and the second content that has a type different from that of the first content. Specifically, the second model generation unit 43 generates the new second model M20 by using a part of the first model M10 in which deep learning has been performed on the relationship held by the combination of the first content related to a non-verbal language, such as an image, or the like, as the first model M10, and the second content related to a language. More specifically, the second model generation unit 43 generates the new second model M20 by using a part of the first model M10 in which deep learning has been performed on the relationship held by the combination of the first content that is related to a still image or a moving image and the sentence that includes therein the explanation of the first content, i.e., the second content that is related to an English caption.

For example, the second model generation unit 43 generates the second model M20 that includes the image learning model L11 that extracts the feature of the first content, such as the input image, or the like, and the image feature input layer L12 that inputs the output of the image learning model L11 to the feature learning model L14, which are included in the first model M10. Here, the second model generation unit 43 may also newly generate the second model M20 that includes at least the image learning model L11. Furthermore, for example, the second model generation unit 43 may also generate the second model M20 by deleting a portion other than the portion of the image learning model L11 and the image feature input layer L12 that are included in the first model M10 and by adding the new language input layer L23, the new feature learning model L24, and the new language output layer L25. Then, the second model generation unit 43 registers the generated second model in the second model database 34.

The second model learning unit 44 allows the second model M20 to perform deep learning on the relationship held by a combination of the first content and the third content that has a type different from that of the second content. For example, the second model learning unit 44 reads the second model from the second model database 34. Then, the second model learning unit 44 performs deep learning on the second model by using the second learning data D20 that is registered in the second learning database 32. Specifically, the second model learning unit 44 allows the second model M20 to perform deep learning on the relationship held by the combination of the first content, such as an image, or the like, and the content that is related to the language different from that of the second content and that explains the associated first content, such as an image, or the like, i.e., the third content that is the caption of the first content. For example, the second model learning unit 44 allows the second model M20 to perform deep learning on the relationship between the Japanese caption D22 that is related to the language different from the language of the English caption D12 included in the first learning data D10 and the image D11.

Furthermore, the second model learning unit 44 optimizes the entirety of the second model M20 such that, when the second learning data D20 is input to the second model M20, the sentence that is output by the second model M20, i.e., the Japanese caption D23, is the same as that of the Japanese caption D22 that is included in the second learning data D20. For example, the second model learning unit 44 inputs the image D11 to the image learning model L11; inputs the Japanese caption D22 to the language input layer L23; and performs optimization, such as back propagation, or the like, such that the Japanese caption D23 that has been output by the language output layer L25 is the same as the Japanese caption D22. Then, the second model learning unit 44 registers the second model M20 that has performed deep learning in the second model database 34.

The information providing unit 45 performs various kinds of information providing processes by using the second model M20 in which deep learning has been performed by the second model learning unit 44. For example, when the information providing unit 45 receives an image from the terminal device 100, the information providing unit 45 inputs the received image to the second model M20 and sends, to the terminal device 100, the Japanese caption D23 that is output by the second model M20 as the caption of the Japanese language with respect to the received image.

### 3. About Learning of Each Model

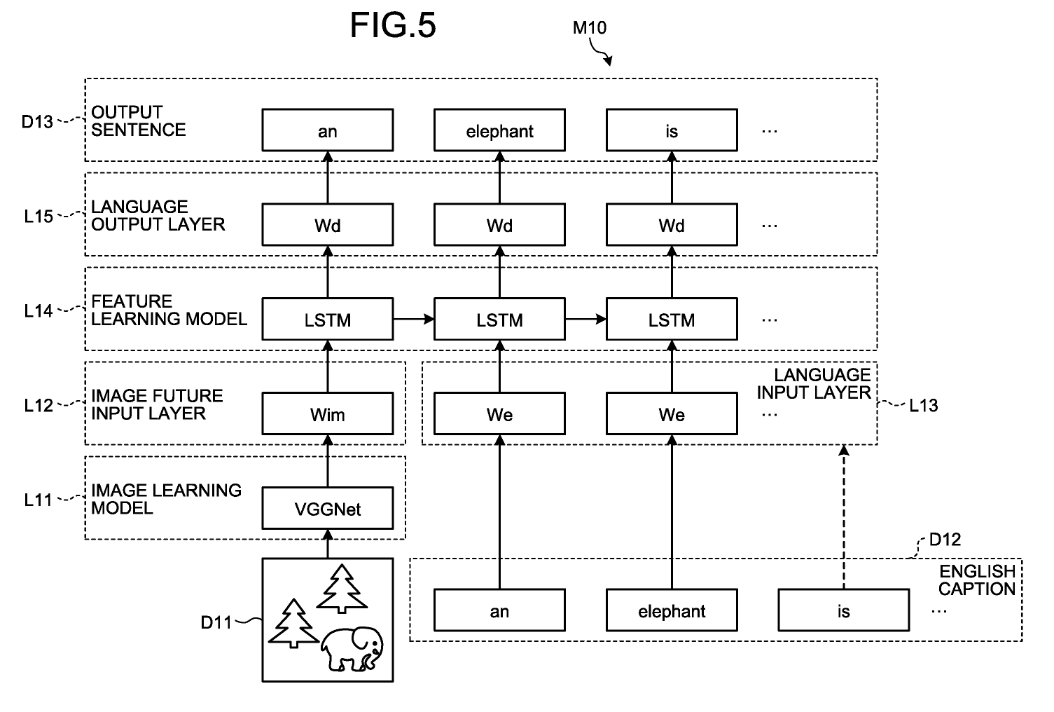

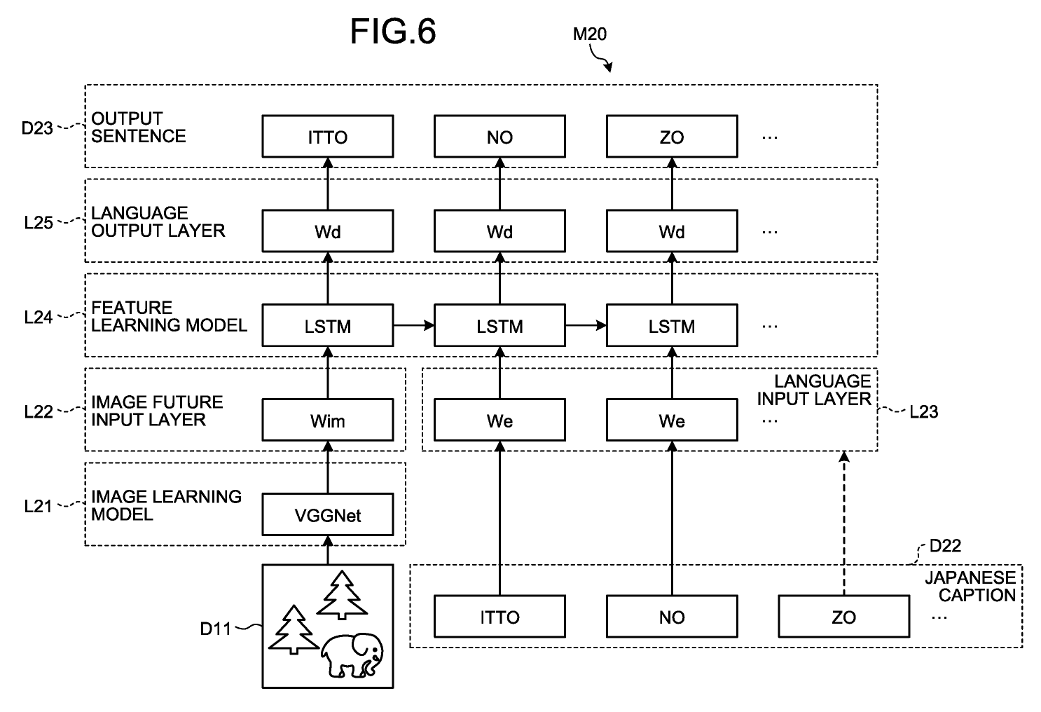

In the following, a specific example of a process in which the information providing device 10 performs deep learning on the first model M10 and the second model M20 will be described with reference to FIGS. 5 and 6. First, a specific example of a process of deep learning performed on the first model M10 will be described with reference to FIG. 5. FIG. 5 is a schematic diagram illustrating an example of a process in which the information providing device according to the embodiment performs deep learning on a first model.

For example, in the example illustrated in FIG. 5, in the image D11, two trees and one elephant are captured. Furthermore, in the example illustrated in FIG. 5, as an explanation of the image D11, a sentence in the English language, such as “an elephant is . . . ”, is included in the English caption D12. When learning the relationship of the first learning data D10 that includes therein the image D11 and the English caption D12 described above, the information providing device 10 performs the deep learning illustrated in FIG. 5. First, the information providing device 10 inputs the image D11 to VGGNet that is the image learning model L11. In such a case, VGGNet extracts the feature of the image D11 and outputs the signal that indicates the extracted feature to Wim that is the image feature input layer L12.

Furthermore, VGGNet is a model that outputs the signal that indicates the capturing target included in the image D11; however, the information providing device 10 can output the signal that indicates the feature of the image D11 to Wim by outputting an input of the intermediate layer of VGGNet to Wim. In such a case, Wim converts the signal that has been input from VGGNet and then inputs the converted signal to LSTM that is the feature learning model L14. More specifically, Wim outputs, to LSTM, the signal that indicates the feature extracted from the image D11 is what kind of feature.

In contrast, the information providing device 10 inputs each of the words described in the English language included in the English caption D12 to We that is the language input layer L13. In such a case, We inputs the signals that indicate the input words to LSTM in the order in which each of the words appears in the English caption D12. Consequently, after having learned the feature of the image D11, LSTM sequentially learns the words included in the English caption D12 in the order in which each of the words appears in the English caption D12.

In such a case, LSTM outputs a plurality of output signals that are in accordance with the learning substance to Wd that is the language output layer L15. Here, the substance of the output signal that is output from LSTM varies in accordance with the substance of the input image D11, the words included in the English caption D12, and the order in which each of the words appears. Then, Wd outputs the English caption D13 that is an output sentence by converting the output signals that are sequentially output from LSTM to words. For example, Wd sequentially outputs English words, such as “an”, “elephant”, “is”.

Here, the information providing device 10 optimizes Wd, LSTM, Wim, We, and VGGNet by using back propagation such that the words included in the English caption D13 that is an output sentence and the order of the appearances of the words are the same as the words included in the English caption D12 and the order of the appearances of the words. Consequently, the feature of the relationship between the image D11 and the English caption D12 learned by LSTM is reflected in VGGNet and Wim to some extent. For example, in the example illustrated in FIG. 5, the association relationship between “zo” (i.e., an elephant in Japanese) captured in the image D11 and the meaning of the word of “elephant” is reflected to some extent.

Subsequently, as illustrated in FIG. 6, the information providing device 10 performs deep learning on the second model M20. FIG. 6 is a schematic diagram illustrating an example of a process in which the information providing device according to the embodiment performs deep learning on a second model. Furthermore, in the example illustrated in FIG. 6, it is assumed that, as an explanation of the image D11, a sentence described in the Japanese language, such as “itto no zo . . . ”, is included in the Japanese caption D22.

For example, the information providing device 10 includes the image learning model L21 and the image feature input layer L22 by using the image learning model L11 as the image learning model L21 and by using the image feature input layer L12 as the image feature input layer L22 and generates the second model M20 that has the same configuration as that of the first model M10. Then, the information providing device 10 inputs the image D11 to VGGNet and sequentially inputs each of the words included in the Japanese caption D22 to We. In such a case, LSTM learns the relationship between the image D11 and the Japanese caption D22 and outputs the learning result to Wd. Then, Wd converts the learning result obtained by LSTM to the words in the Japanese language and then sequentially outputs the words. Consequently, the second model M20 outputs the Japanese caption D23 as an output sentence.

Here, the information providing device 10 optimizes Wd, LSTM, Wim, We, and VGGNet by using back propagation such that the words included in the Japanese caption D23 that is an output sentence and the order of the appearances of the words are the same as the words included in the Japanese caption D22 and the order of the appearances of the words. However, in VGGNet and Wim illustrated in FIG. 6, the association relationship between “zo” (i.e., an elephant in Japanese) captured in the image D11 and the meaning of the word of “elephant” is reflected to some extent. Here, it is predicted that the meaning of the word of “elephant” is the same as that of the word represented by “zo”. Thus, it is conceivable that the second model M20 can learn the association between the “elephant” captured in the image D11 and the word of “zo” without a large number of pieces of the second learning data D20.

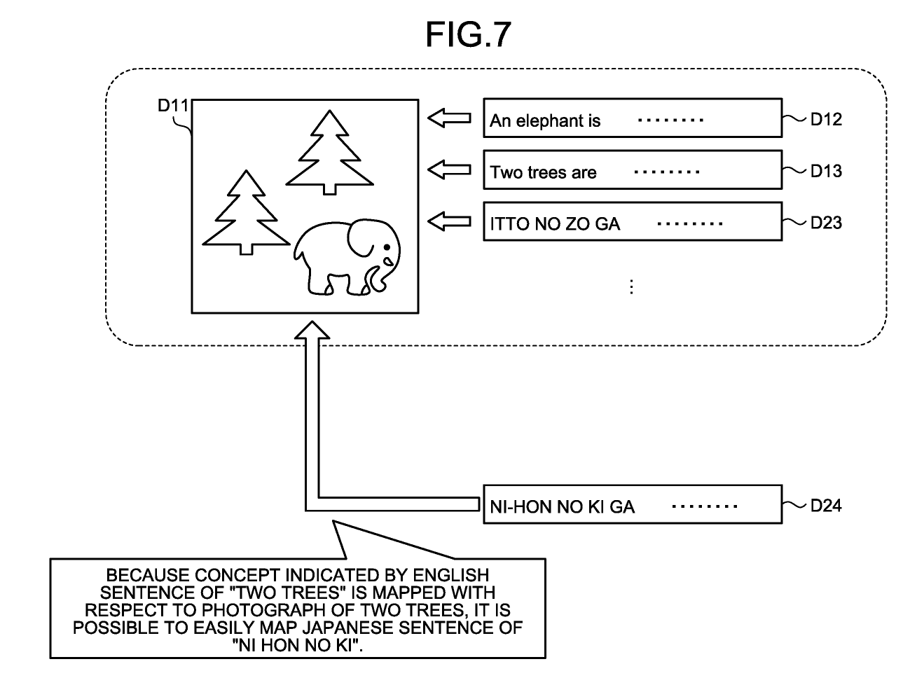

Furthermore, if the second model M20 is generated by using a part of the first model M10 in this way, it is possible to learn the relationship between the first learning data D10 in which the sufficient number of pieces of data is included and the second learning data D20 in which the insufficient number of pieces of data is included. For example, FIG. 7 is a schematic diagram illustrating an example of the result of the learning process performed by the information providing device according to the embodiment.

In the example illustrated in FIG. 7, it is assumed that the first learning data D10 in which the English caption D12, such as “An elephant is . . . ”, or the like, is associated with the English caption D13, such as “Two trees are . . . ”, or the like, is present in the image D11. Furthermore, in the example illustrated in FIG. 7, it is assumed that the second learning data D20 in which the Japanese caption D23, such as “one elephant is . . . ”, or the like, is associated is present in the image D11.

When learning the first model M10 by using the first learning data D10 described above, in the image learning portion included in the first model M10, in addition to the association between the elephant included in the image D11 and the meaning of the English word of “elephant”, the association between the plurality of trees included in the image D11 and the English word of “Trees” is reflected to some extent. Consequently, in the second model M20 that includes the image learning portion of the first model M10, because the concept indicated by the English sentence of “Two trees” with respect to the image D11 that is the photograph in which two trees are captured is mapped, the sentence of “ni-hon no ki” described in the Japanese language can easily be mapped. Consequently, for example, even if the Japanese caption D24 such as “ni-hon no ki ga . . . ”, or the like, that focuses on the trees captured in the image D11 is insufficient, the second model M20 can learn the relationship between the image D11 and the Japanese caption D24 with high accuracy. Furthermore, for example, if the English caption, such as the English caption D13, that focuses on the trees is sufficiently present, even if the Japanese caption D24 that focuses on the trees is not present, there is a possibility that the second model M20 that outputs the Japanese caption focusing on the trees when the image D11 is input can be generated.

### 4. Modification

In the above description, an example of the learning process performed by the information providing device 10 has been described. However, the embodiment is not limited to this. In the following, a variation of the learning process performed by the information providing device 10 will be described.

### 4-1. About the Type of the Content to be Leaned by the Model

In the example described above, the information providing device 10 generates the second model M20 by using a part of the first model M10 in which deep learning has been performed on the relationship between the image D11 and the English caption D12 that is a language and allows the second model M20 to perform deep learning on the relationship between the image D11 and the Japanese caption D22 described in a language that is different from that of the English caption D12. However, the embodiment is not limited to this.

For example, the information providing device 10 may also allow the first model M10 to perform deep learning on the relationship between the moving image and the English caption and may also allow the second model M20 to perform deep learning on the relationship between the moving image and the Japanese caption. Furthermore, the information providing device 10 may also allow the second model M20 to perform deep learning on the relationship between an image or a moving image and a caption in an arbitrary language, such as the Chinese language, the French language, the German language, or the like. Furthermore, in addition to the caption, the information providing device 10 may also allow the first model M10 and the second model M20 to perform deep learning on the relationship between an arbitrary sentence, such as a novel, a column, or the like and an image or a moving image.

Furthermore, for example, the information providing device 10 may also allow the first model M10 and the second model M20 to perform deep learning on the relationship between music content and a sentence that evaluates the subject music content. If such a learning process is performed, for example, although the number of reviews described in the English language is great in a distribution service of the music content, the information providing device 10 can learn the second model M20 that can accurately generate reviews from the music content even if the number of reviews described in the Japanese language is small.

Furthermore, there may also be a case in which a service that generates a summary from news in the English language is present but the accuracy of a service that generates a summary from news in the Japanese language is not very good. Thus, when the information providing device 10 inputs the image D11 and the news described in the English language, the information providing device 10 may also allow the first model M10 to perform deep learning such that the first model M10 outputs the summary of the news in the English language and, when the image D11 and the news described in the Japanese language are input by using a part of the first model M10, the information providing device 10 may also allow the second model M20 to perform deep learning such that the second model M20 outputs the summary of the news described in the Japanese language. If the information providing device 10 performs such a process, even if the number of pieces of the learning data is small, the information providing device 10 can perform the learning on the second model M20 that generates a summary of the news described in the Japanese language with high accuracy.

Namely, the information providing device 10 can use content with an arbitrary type as long as the information providing device 10 allows the first model M10 to perform deep learning on the relationship between the first content and the second content and allows the second model M20 that uses a part of the first model M10 to perform deep learning on the relationship between the first content and the third content that has a type different from that of the second content and in which the relationship with the first content is similar to that with the second content.

### 4-2. About a Portion of the First Model to be Used

In the learning process, the information providing device 10 generates the second model M20 by using the image learning portion in the first model M10. Namely, the information providing device 10 generates the second model M20 in which a portion other than the image learning portion in the first model M10 is deleted and a new portion is added. However, the embodiment is not limited to this. For example, the information providing device 10 may also generate the second model M20 by deleting a part of the first model M10 and adding a new portion to be substituted. Furthermore, the information providing device 10 may also generate the second model M20 by extracting a part of the first model M10 and by adding a new portion to the extracted portion. Namely, the information providing device 10 may also extract a part of the first model M10 and may also delete an unneeded portion in the first model M10 as long as the information providing device 10 extracts a part of the first model M10 and generates the second model M20 by using the extracted portion. A partial deletion or extraction of the first model M10 performed in this way is a process as a matter of convenience performed in handling data and an arbitrary process can be used as long as the same effect can be obtained.

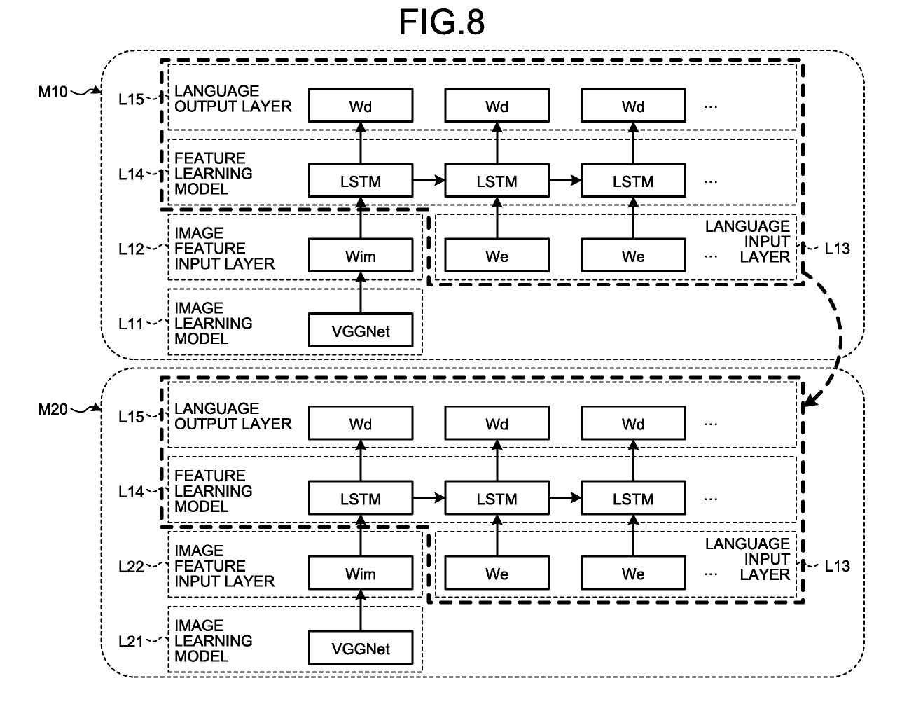

For example, FIG. 8 is a schematic diagram illustrating the variation of the learning process performed by the information providing device according to the embodiment. For example, similarly to the learning process described above, the information providing device 10 generates the first model M10 that includes each of the layers L11 to L15. Then, as indicated by the dotted thick ling illustrated in FIG. 8, the information providing device 10 may also generate the new second model M20 by using the portion other than the image learning portion in the first model M10, i.e., by using the language learning units including the language input layer L13, the feature learning model L14, and the language output layer L15.

In the second model M20 obtained as the result of such a process, the relationship learned by the first model M10 is reflected to some extent. Thus, if the second learning data D20 is similar to the first learning data D10, even if the number of pieces of the second learning data D20 is small, the information providing device 10 can perform deep learning on the second model M20 that accurately learn the relationship of the second learning data D20.

Furthermore, for example, if the language of the sentence included in the first learning data D10 is similar to the language of the sentence included in the second learning data D20 (for example, the Italian language and the Latin language), the information providing device 10 many also generate the second model M20 by using, in addition to the image learning portion in the first model M10, the feature learning model L14. Furthermore, the information providing device 10 may also generate the second model M20 by using a portion of the feature learning model L14. By performing such a process, the information providing device 10 can allow the second model M20 to perform deep learning on the relationship of the second learning data D20 with high accuracy.

Furthermore, for example, instead of the image learning portion, the information providing device 10 performs deep learning on the first model M10 that includes a model that generates a summary from the news and generates, in the first model M10, the second model M20 in which the model that generates the summary from the news is changed to the image learning portion, whereby the information providing device 10 may also generate the second model M20 that generates an article of the news from the input image. Namely, if the information providing device 10 generates the second model M20 by using a part of the first model M10, the configuration of the portion that is included in the second model M20 and that is not included in the first model M10 may also be the configuration different from the configuration of the portion that is included in the first model M10 and that is not used for the second model M20.

### 4-3. About Learning Substance

Furthermore, the information providing device 10 can use an arbitrary setting related to optimization of the first model M10 and the second model M20. For example, the information providing device 10 may also perform deep learning such that the second model M20 responds to a question with respect to an input image. Furthermore, the information providing device 10 may also perform deep learning such that the second model M20 responds to an input text by a sound. Furthermore, the information providing device 10 may also perform deep learning such that, if a value indicating the taste of food acquired by a taste sensor or the like is input, the information providing device 10 outputs a sentence that represents the taste of the food.

### 4-4. Configuration of the Device

Furthermore, the information providing device 10 may also be connected to an arbitrary number of the terminal devices 100 such that the devices can perform communication with each other or may also be connected to an arbitrary number of the data servers 50 such that the devices can perform communication with each other. Furthermore, the information providing device 10 may also be implemented by a front end server that sends and receives information to and from the terminal device 100 or may also be implemented by a back end server that performs the learning process. In this case, the front end server includes therein the second model database 34 and the information providing unit 45 that are illustrated in FIG. 2, whereas the back end server includes therein the first learning database 31, the second learning database 32, the first model database 33, collecting unit 41, the first model learning unit 42, the second model generation unit 43, and the second model learning unit 44 that are illustrated in FIG. 2.

### 4-5. Others

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the second model generation unit 43 and the second model learning unit 44 illustrated in FIG. 2 may also be integrated.

Furthermore, each of the embodiments described above can be appropriately used in combination as long as the processes do not conflict with each other.

### 5. Flow of the Process Performed by the Information Providing Device

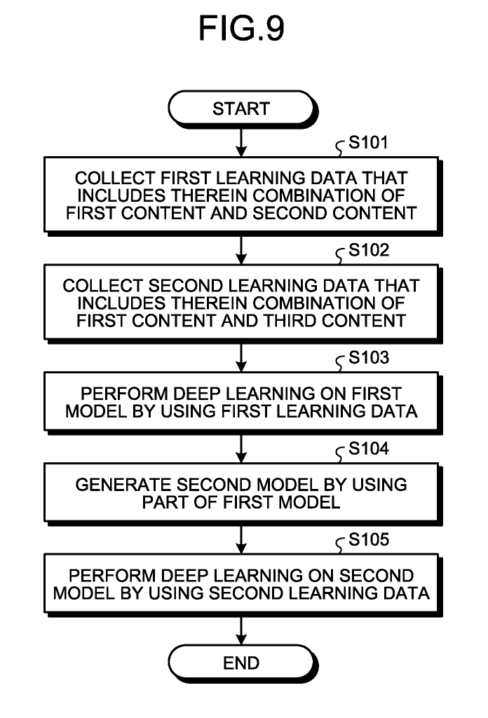

In the following, an example of the flow of the learning process performed by information providing device 10 will be described with reference to FIG. 9. FIG. 9 is a flowchart illustrating the flow of the learning process performed by the information providing device according to the embodiment. For example, the information providing device 10 collects the first learning data D10 that includes therein a combination of the first content and the second content (Step S101). Then, the information providing device 10 collects the second learning data D20 that includes therein a combination of the first content and the third content (Step S102). Furthermore, the information providing device 10 performs deep learning on the first model M10 by using the first learning data D10 (Step S103) and generates the second model M20 by using a part of the first model M10 (Step S104). Then, the information providing device 10 performs deep learning on the second model M20 by using the second learning data D20 (Step S105), and ends the process.

### 6. Program

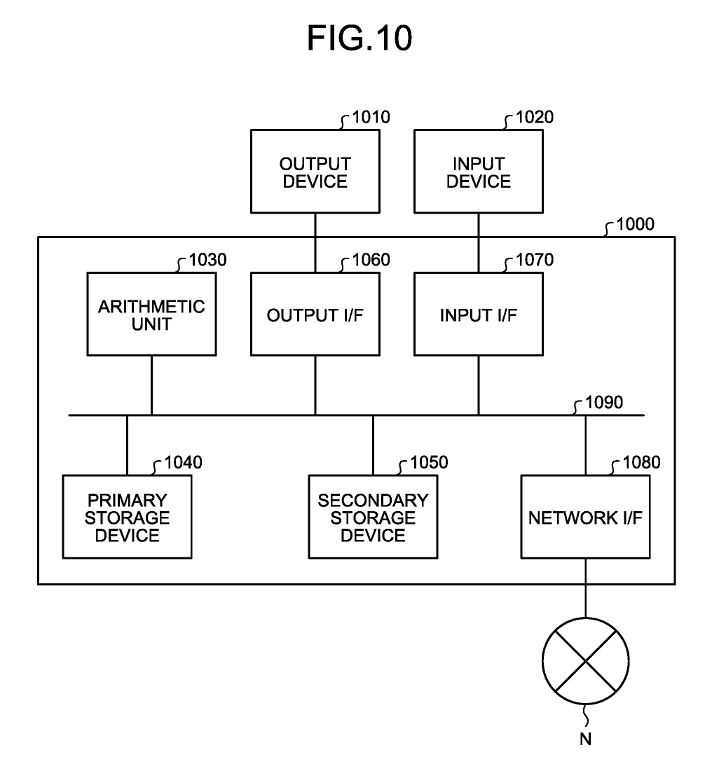

Furthermore, the terminal device 100 according to the embodiment described above is implemented by a computer 1000 having the configuration illustrated in, for example, FIG. 10. FIG. 10 is a block diagram illustrating an example of the hardware configuration. The computer 1000 is connected to an output device 1010 and an input device 1020 and has the configuration in which an arithmetic unit 1030, a primary storage device 1040, a secondary storage device 1050, an output interface (I/F) 1060, an input I/F 1070, and a network I/F 1080 are connected via a bus 1090.

The arithmetic unit 1030 is operated on the basis of the programs stored in the primary storage device 1040 or the secondary storage device 1050 or is operated on the basis of the programs that are read from the input device 1020 and performs various kinds of processes. The primary storage device 1040 is a memory device, such as a RAM, or the like, that primarily stores data that is used by the arithmetic unit 1030 to perform various kinds of arithmetic operations. Furthermore, the secondary storage device 1050 is a storage device in which data that is used by the arithmetic unit 1030 to perform various kinds of arithmetic operations and various kinds of databases are registered and is implemented by a read only memory (ROM), an HDD, a flash memory, and the like.

The output I/F 1060 is an interface for sending information that is targeted for an output with respect to the output device 1010, such as a monitor, a printer, or the like, that output various kinds of information, and is implemented by, for example, the standard connector, such as a universal serial bus (USB), a digital visual interface (DVI), a High Definition Multimedia Interface (registered trademark) (HDMI), or the like. Furthermore, the input I/F 1070 is an interface for receiving information from various kinds of the input device 1020 such as a mouse, a keyboard, a scanner, or the like and is implemented by, for example, an USB, or the like.

Furthermore, the input device 1020 may also be, for example, an optical recording medium, such as a compact disc (CD), a digital versatile disc (DVD), a phase change rewritable disk (PD), or the like, or a device that reads information from a tape medium, a magnetic recording medium, a semiconductor memory, or the like. Furthermore, the input device 1020 may also be an external storage medium, such as a USB memory, or the like.

The network I/F 1080 receives data from another device via the network N and sends the data to the arithmetic unit 1030. Furthermore, the network I/F 1080 sends the data generated by the arithmetic unit 1030 to the other device via the network N.

The arithmetic unit 1030 controls the output device 1010 or the input device 1020 via the output I/F 1060 or the input I/F 1070, respectively. For example, the arithmetic unit 1030 loads the program from the input device 1020 or the secondary storage device 1050 into the primary storage device 1040 and executes the loaded program.

For example, if the computer 1000 functions as the terminal device 100, the arithmetic unit 1030 in the computer 1000 implements the function of the control unit 40 by performing the program loaded in the primary storage device 1040.

### 7. Effects

As described above, the information providing device 10 generates the new second model M20 by using a part of the first model M10 in which deep learning has been performed on the relationship held by a combination of the first content and the second content that has a type different from that of the first content. Then, the information providing device 10 allows the second model M20 to perform deep learning on the relationship held by a combination of the first content and the third content that has a type different from that of the second content. Consequently, the information providing device 10 can prevent the degradation of the accuracy of the learning of the relationship between the second content and the third content even if the number of pieces of the second learning data D20, i.e., the combination of the second content and the third content, is small.

Furthermore, the information providing device 10 generates the new second model M20 by using a part of the first model M10 in which deep learning has been performed on the relationship held by the combination of the first content related to a non-verbal language and the second content related to a language. Then, the information providing device 10 allows the second model M20 to perform deep learning on the relationship held by the combination of the first content and the third content that is related to the language that is different from that of the second content.

More specifically, the information providing device 10 generates the new second model M20 by using the part of the first model M10 in which deep learning has been performed on the relationship held by the combination of the first content that is related to a still image or a moving image and the second content that is related to a sentence. Then, the information providing device 10 allows the second model M20 to perform deep learning on the relationship held by the combination of the first content and the third content that includes therein a sentence in which an explanation of the first content is included and that is described in a language different from that of the second content.

For example, the information providing device 10 generates the new second model M20 by using the part of the first model M10 in which deep learning has been performed on the relationship held by the combination of the first content and the second content that is the caption of the first content described in a predetermined language. Then, the information providing device 10 allows the second model M20 to perform deep learning on the relationship held by the combination of the first content and the third content that is the caption of the first content described in the language that is different from the predetermined language.

After having performed the processes described above, consequently, the information providing device 10 generates the second model M20 by using the part of the first model M10 that has learned the relationship between, for example, the image D11 and the English caption D12 and allows the second model M20 to perform deep learning on the relationship between the image D11 and the Japanese caption D22. Consequently, the information providing device 10 can prevent the degradation of the accuracy of the learning performed by the second model M20 even if the number of combinations of, for example, the image D11 and the Japanese caption D22 is small.

Furthermore, the information providing device 10 generates the second content by using the part of a learner, as the first model M10, in which the entirety of the learner has been optimized so as to output the content having the same substance as that of the second content when the first content and the second content are input. Consequently, because the information providing device 10 can generate the second model M20 in which the relationship learned by the first model M10 is reflected to some extent, even if the number of pieces of learning data is small, the information providing device 10 can prevent the degradation of the accuracy of the learning performed by the second model M20.

Furthermore, the information providing device 10 generates the second model M20 in which an addition of a new portion or a deletion is performed on a part of the first model M10. For example, the information providing device 10 generates the second model M20 in which an addition of a new portion or a deletion is performed on a part of the first model M10 that is obtained by deleting a part of the first model M10. Furthermore, for example, the information providing device 10 generates the second model M10 by deleting a part of the first model M10 and adding a new portion to the remaining portion. For example, from among a first portion (for example, the image learning model L11) that extracts the feature of the first content that has been input, a second portion (for example, the language input layer L13) that accepts an input of the second content, and a third portion (for example, the feature learning model L14 and the language output layer L15) that outputs, on the basis of output of the first portion and an output of the second portion, the content having the same substance as that of the second content that are included in the first model M10 the information providing device 10 generates the new second model M20 by using at least the first portion. Consequently, because the information providing device 10 can generate the second model M20 in which the relationship learned by the first model M10 is reflected to some extent, even if the number of pieces of the learning data is small, the information providing device 10 can prevent the degradation of learning performed by the second model M20.

Furthermore, the information providing device 10 generates the new second model M20 by using the first portion and one or a plurality of layers (for example, the image feature input layer L12), from among the portions included in, that inputs an output of the first portion to the second portion included in the first model M10. Consequently, because the information providing device 10 can generate the second model M20 in which the relationship learned by the first model M10 is reflected to some extent, even if the number of pieces of the learning data is small, the information providing device 10 can prevent the degradation of learning performed by the second model M20.

Furthermore, the information providing device 10 allows the second model M20 to perform deep learning such that, when the combination of the first content and the third content is input, the content having the same substance as that of the third content is output. Consequently, the information providing device 10 can allow the second model M20 to accurately perform deep learning on the relationship held by the first content and the third content.

Furthermore, the information providing device 10 generates the new second model M20 by using the second portion and the third portion from among the portions included in the first model M10 and allows the second model M20 to perform deep learning on the relationship held by the combination of the second content and fourth content that has a type different from that of the first content. Consequently, even if the number of combinations of the second content and the fourth content is small, the information providing device 10 can allow the second model M20 to accurately perform deep learning on the relationship held by the second content and the fourth content.

Furthermore, the “components (sections, modules, units)” described above can be read as “means”, “circuits”, or the like. For example, a distribution unit can be read as a distribution means or a distribution circuit.

According to an aspect of an embodiment, an advantage is provided in that it is possible to prevent degradation of accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning device comprising:
a generating unit that generates a new second learner by using a part of a first learner in which deep learning has been performed on the relationship held by a combination of first content and second content that has a type different from that of the first content; and
a learning unit that allows the second learner generated by the generating unit to perform deep learning on the relationship held by a combination of the first content and third content that has a type different from that of the second content.

2. The learning device according to claim 1, wherein
the generating unit generates the new second learner by using the part of the first learner in which deep learning has been performed on the relationship held by the combination of the first content related to a non-verbal language and the second content related to a language, and
the learning unit allows the second learner to perform deep learning on the relationship held by the combination of the first content and the third content that is related to a language different from that of the second content.

3. The learning device according to claim 1, wherein
the generating unit generates the new second learner by using the part of the first learner, as the first learner, in which deep learning has been performed on the relationship held by the combination of the first content related to a still image or a moving image and the second content related to a sentence, and
the learning unit allows the second learner to perform deep learning on the relationship held by the combination of the first content and the third content that includes therein a sentence in which an explanation of the first content is included and that is described in a language different from that of the second content.

4. The learning device according to claim 3, wherein
the generating unit generates the new second learner by using the part of the first learner in which deep learning has been performed on the relationship held by the combination of the first content and the second content that is a caption of the first content described in a predetermined language, and
the learning unit allows the second learner to perform deep learning on the relationship held by the combination of the first content and the third content that is the caption of the first content and that is described in the language different from the predetermined language.

5. The learning device according to claim 1, wherein the generating unit generates the second content by using a part of a learner as the first learner in which the entirety of the learner has been optimized such that the learner outputs the content having the same substance as that of the second content when the first content and the second content are input.

6. The learning device according to claim 1, wherein the generating unit generates the learner in which an addition of a new portion or a deletion is performed on a part of the first learner.

7. The learning device according to claim 1, wherein, from among a first portion that extracts the feature of the input first content, a second portion that accepts an input of the second content, and a third portion that outputs, on the basis of an output of the first portion and an output of the second portion, the content having the same substance as that of the second content that are included in the learner, the generating unit generates the new second learner by using at least the first portion.

8. The learning device according to claim 7, wherein the generating unit generates the new second learner by using the first portion and one or a plurality of layers that inputs the output of the first portion to the second portion included in the first learner.

9. The learning device according to claim 1, wherein the learning unit allows the second learner to perform deep learning such that, when the combination of the first content and the third content is input, the content having the same substance as that of the third content is output.

10. The learning device according to claim 1, wherein, from among a first portion that extracts the feature of the input first content, a second portion that accepts an input of the second content, and a third portion that outputs, on the basis of an output of the first portion and an output of the second portion, the content having the same substance as that of the second content that are included in the learner, the generating unit generates a new third learner by using the second portion and the third portion, and
the learner allows to learn the relationship held by the combination of the second content and fourth content that has a type different from that of the first content.

11. A learning method performed by a learning device, the learning method comprising:
generating a new second learner by using a part of a first learner in which deep learning has been performed on the relationship held by a combination of first content and second content that has a type different from that of the first content; and
allowing the second learner generated at the generating to perform deep learning on the relationship held by a combination of the first content and third content that has a type different from that of the second content.

12. A non-transitory computer readable storage medium having stored therein a program causing a computer to execute a process comprising:
generating a new second learner by using a part of a first learner in which deep learning has been performed on the relationship held by a combination of first content and second content that has a type different from that of the first content; and
allowing the second learner generated at the generating to perform deep learning on the relationship held by a combination of the first content and third content that has a type different from that of the second content.
